(19) United States
(12) Patent Application Publication
(10) Pub. No.: US 2026/0237653 A1
(43) Pub. Date: Aug. 13, 2026

(54) AIR AND MOISTURE STABLE HIGH-CAPACITY POSITIVE ELECTRODE MATERIALS FOR SODIUM-ION BATTERY

(71) Applicant: Council of Scientific and Industrial Research, New Delhi (IN)

(72) Inventors: Annigere Sannalingegowda Prakash, Chennai (IN); Gogula Sudheer Kumar, Chennai (IN); Vasantha Annigere Gangadharappa, Chennai (IN)

(21) Appl. No.: 19/152,256

(22) PCT Filed: Jan. 17, 2024
(86) PCT No.: PCT/IN2024/050041

§ 371 Date: Jul. 30, 2025

(30) Foreign Application Priority Data
Feb. 2, 2023 (IN) 202311006895

(51) Int. Cl. H01M 4/525; C01G 53/51; H01M 4/36; H01M 10/054

(52) U.S. Cl. CPC H01M 4/525; C01G 53/51; H01M 4/366; H01M 10/054; C01P 2002/50; C01P 2002/52; C01P 2002/54; C01P 2002/72; C01P 2002/76; C01P 2004/03; C01P 2006/40

(57) ABSTRACT

The present invention relates to a sodium-ion battery comprising positive electrode compositions possessing improved battery performance and moisture and air stability. The positive electrode composition having a general formula NaₓA_{z}NiᵢM_{y}MnⱼTiₖSb_{f}O₂ where A is alkali or alkaline-earth metals selected from Ca, Li, M is divalent or trivalent element selected from Fe, Mg, Zn, Cu, Al, Co, and Ni is divalent element, Mn, Ti is tetravalent element and Sb is pentavalent/trivalent element where (i+j+k+f+y=1), 0.7≤x≤1, 0≤z≤0.2, 0.1≤i≤0.6, 0≤y≤0.5, 0.1≤j≤0.5, 0.05≤k≤0.4, 0≤f≤0.2, The present invention is applicable to energy storage applications.

### FIELD OF INVENTION

The present invention relates to sodium-ion battery comprising positive electrode compositions possessing improved battery performance and moisture and air stability. More particularly, the invention relates to manganese transition metal and other transition metals such as Ni and Fe together with Ca, Cu and Ti which are incorporated into the structure of sodium for better air and moisture stability. Further, the invention relates to the compositions having a general formula NaₓA_{z}NiᵢM_{y}MnⱼTiₖSb_{f}O₂ where A is alkali or alkaline-earth metals selected from Ca, Li, M is divalent or trivalent element selected from Fe, Mg, Zn, Cu, Al, Co, and Ni is divalent element, Mn, Ti is tetravalent element and Sb is pentavalent/trivalent element where (i+j+k+f+y=1), 0.7≤x≤1, 0≤z≤0.2, 0≤y≤0.5, 0.1≤i≤0.6, 0.1≤j≤0.5, 0.05≤k≤0.4, 0≤f≤0.2. The present invention is pertinent to grid storage applications.

### BACKGROUND OF THE INVENTION

Large-scale energy storage systems have attracted increasing interest recently, However The relatively low abundance of lithium, cobalt and nickel resources on earth and their uneven distribution cannot meet the increased demands on large-scale energy storage systems. Sodium ion secondary batteries are the potential alternative to Li-ion secondary batteries. The large demand and cost considerations may require the application of Na-ion batteries (NIBs) rather than Li-ion batteries due to the abundance and wide distribution of sodium resources. In many aspects sodium behaves electrochemically similar to lithium.

According to the coordination environment of sodium ions in the structure, NaₓTMO₂ (where TM=transition metal e.g., Co, Ni, Mn, Fe, Cu etc.) can be roughly divided into P-types (prismatic coordination) and O-types (octahedral) with P2 and O3 phases as the most common structural types. Various categories of potential cathode materials have been studied including transition metal oxides, Prussian blue analogues, and polyanionic compounds. Among those, layered transition-metal oxides are appealing candidates, due to the merits of easy synthesis, high energy density and feasibility for mass production.

One of the key issues with layered oxide cathode materials is air and moisture stability. Air sensitive materials require special manufacturing conditions, they must be prepared, stored and assembled in dry or even inert atmospheres which inevitably increases cost. As a targeted application of sodium ion batteries is large scale grid energy storage system, the cost is a paramount factor. We need an effective technology that empowers a cathode with water processable properties. To promote the practical application of sodium-ion batteries, their poor air and moisture stability needs to be understood and resolved. This problem is addressed in the present invention.

Here we have come up with an important strategy to improve stability towards air and moisture of cathode materials. The elemental substitution in either transition-metal sites or sodium sites and by reducing the sodium content and raising the open-circuit voltage, layered materials gain anti-oxidation stability, The introduction of copper, calcium and Titanium is an important element that improves air & moisture stability and further maintain specific capacity values of 120-140 mAh/g.

Reference may be made to an article Feng Lin et al Journal of The Electrochemical Society 2019, 166 (2) A251-A257, had reported a material P2-Na_{0.67}Ni_{0.22}Cu_{0.11}Mn_{0.56}Ti_{0.11}O₂ and its performance under water-processing conditions. This material achieves a discharge capacity of 180 mAhg⁻¹ and a discharge energy of 544 Wh kg⁻¹ at 22° C. The aging experiments indicate its superior stability against water, having negligible bulk structural or chemical changes. However, P2-Phases are sodium deficient and making full cell without the use of sodiated anode materials is not practical. Further, the high specific capacity in this composition is attributed to the manganese redox which occurs below 2V. The surface sensitive soft X-ray absorption spectroscopy shows that the cathode has stable surface chemistry in the aqueous solution. Moreover, the cells with water-processed cathodes delivered stable cycling performance with minor voltage decay, originating from the decreased cell impedance.

Reference may be made to an article Mark N. Obrovac et al, ACS applied materials and interfaces 2018, 10, 44, 38246-38254, had reported the sensitivity of NaNi_{0.5}Mn_{0.5}O₂ towards air exposure was studied in detail by XRD structural analysis, surface analysis by SEM imaging and FTIR spectroscopy, and by electrochemical measurements. The reactions that occur when NaNi_{0.5}Mn_{0.5}O₂ is exposed to air are complex. Washing NaNi_{0.5}Mn_{0.5}O₂ with water completely destroys the structure, while washing with ethanol does not cause significant structural damage. Instead, ethanol washing removes most of the sodium residues on NaNi_{0.5}Mn_{0.5}O₂ surfaces.

Reference may be made to an article Yunming Li et al advanced sciences 2015, 2(6): 1500031 had designed a novel air-stable cathode. P2 type Na_{7/9}Cu_{2/9}Fe_{1/9}Mn_{2/3}O₂ with high sodium content and investigated its electrochemical performance as a positive electrode material for rechargeable sodium-ion batteries. This material exhibits a reversible capacity of 89 mAh g⁻¹ at 0.1C rate. The attractive performance is the long cycling stability as demonstrated by the capacity retention of 85% after 150 cycles at 1C rate without phase transformation. When coupled with hard carbon negative electrode, promising application prospects were demonstrated with a high reversible capacity of 313 mAh g⁻¹, high initial Coulombic efficiency of 79%, and a high energy density of 195 Wh kg⁻¹ at 0.2C rate.

Reference may be made to an article Shi-Xue Dou et al Advanced energy materials. 2018, 8, 1701610, had reported a novel air-stable O3-type Na[Li_{0.05}Mn_{0.50}Ni_{0.30}Cu_{0.10}Mg_{0.05}]O₂ cathode which is synthesized by a coprecipitation method followed by high-temperature annealing. It exhibits a reversible capacity of 172 mAhg⁻¹ at 0.1 C and remarkable capacity retention of 70.4% after 1000 cycles at 20 C. More importantly, it offers good compatibility with pristine hard carbon as anode in the sodium-ion full cell. It delivered a high energy density of up to 215 W h kg⁻¹ at 0.1 C and good rate performance.

Reference may be made to an article Yu-Guo et al journal of American chemical society 2017, 139, 25, 8440-8443, had reported combined structure modulation strategy is suggested to improve the air stability of O3 type cathode materials via reducing the interlayer distance of Na layers and simultaneously increasing valance state of transition metals. the cathode NaNi_{0.5}Mn_{0.5}O₂ via Cu/Ti co-doping. The as-obtained NaNi_{0.45-x}Cu₀ₓMn_{0.4-y}Ti_{y}O₂ where 0.05≤x≤0.1 and 0≤y≤0.1 exhibits an increase of 20 times in stable air-exposure period and 9 times in capacity retention after 500 cycles, and even retains its original structure and capacity after being soaked in water.

Reference may be made to patent WO 2016/188877 the invention describes that the specific bivalent metal ions, more particularly any one or more of Cu, Ni and Zn doping is applied to sodium cathode materials for providing a sodium ion battery having large high-rate performance and a good calendar life. Positive electrodes having a composition NaₓM_{y}Mn_{1-y}Li_{y}·A_{z}O₂ or NaₓM_{y}Mn_{1-y}O₂ with 0.60<x<0.95, wherein M consists of either one or more elements of the group consisting of Cu, Zn and Ni, with 0.05≤y<0.20, A consisting of either one or more elements of the group consisting of Mg, Ti, Fe, Cr and Co, 0≤z<0.2, 0≤y′<0.33, and z+y′>0. The invention also provides a process for preparing sodium layered oxide materials, and there applications thereof.

Reference may be made to patent US 2022/0013772 A1 The invention relates to positive electrode materials for sodium-ion battery. The cathode active material for sodium-ion battery has the following formula: NaₓNi_{0.5-y}Cu_{y}Mn_{0.5-z}Ti_{z}O₂, in which: −x varies from 0.9 to 1; −y varies from 0.05 to 0.1; −Z varies from 0.1 to 0.3. When z is equal to 0.1 and x is equal to 1, then y is not equal to 0.05. The invention relates to a method for producing the claimed sodium metal oxide compositions. Finally, the invention also relates to a particular cycling method for the Na-ion batteries comprising a particular positive-electrode active material.

Thus, keeping in view the drawbacks of the hitherto reported prior arts, there is a scope to improve the characteristics of cathode materials by providing multivalent layered oxide compositions to enhance the capacity performance, average working voltage, cycle life, structural stability, moisture and air stability and large-scale production.

### Objective of the Invention

The main objective of the present invention is to develop high capacity, cost effective, moisture and air stable cathode materials for a sodium ion battery application.

Another objective of the invention is that the multivalent cathode composition wherein elements are chosen in such a way that the combination of elements will provide enhanced structural, thermal, air and moisture stability, higher average potential, higher redox contributing to increased capacity and enhanced Sodium-ion diffusion kinetics.

Another objective of the invention is to provide a cost-effective electrode that contains an active material that is simple to prepare and easy to handle and store.

Another objective of the invention is incorporation of a small amount of Ca at the Sodium site and Cu into transition metal site which improves the structural, moisture and air stability.

Yet another objective of the invention is the use of high valence element such as Sb⁺⁵ in the structure to stabilize 3d metal in lower valent state to utilize the complete redox of M⁺²/M⁺³/M⁺⁴ to yield higher specific capacity values. Further glassy forming nature of antimony oxide helps in easy synthesis and pure phase formation.

Another objective of the present invention to provide sodium metal oxide compositions as positive electrode for Sodium-ion battery which is cheaper than the prior art compositions and easily scalable for mass production.

### SUMMARY OF THE INVENTION

In the present invention the alkali and alkaline-earth metals and transition metals are used to obtain sodium positive electrode materials with high-capacity, moisture and air stability. The compositions having the general formula NaₓA_{z}NiᵢM_{y}MnⱼTiₖSb_{f}O₂ where A is alkali or alkaline-earth metals selected from Ca, Li, M is divalent or trivalent element selected from Fe, Mg, Zn, Cu, Al, Co, and Ni is divalent element, Mn, Ti is tetravalent element and Sb is pentavalent/trivalent element where (i+j+k+e+y=1), 0.7≤x≤1, 0≤z≤0.2, 0≤y≤0.5, 0.1≤i≤0.6, 0.1≤j≤0.5, 0.05≤k≤0.4, 0≤f≤0.2. According to embodiment of the present invention the concentration of element Na ‘x’ may range from 0.7 to 1, the concentration of element A ‘z’ may range from 0 to 0.2, the concentration of element Ni ‘i’ may range from 0.1 to 0.6 is divalent element, the concentration of element M ‘y’ may range from 0. to 0.5 and is divalent or trivalent element selected from Fe, Mg, Zn, Cu, Al, Co, or combination thereof. The concentration of element Mn ‘j’ may range from 0.1 to 0.5 and is tetravalent element, the concentration of element Ti ‘d’ may range from 0.05 to 0.4 and is tetravalent element, the concentration of element Sb ‘f’ may range from 0 to 0.2 and is pentavalent/trivalent element (wherein x, i, j, k, f and y are chosen in such way that overall electroneutrality is maintained).

According to embodiments of the present invention the compositions were synthesized by a simple solid-state method.

According to embodiments of the present invention, cathode material compositions exhibit good cycling stability, high operating voltage and good rate performance.

According to embodiments of the present invention, wherein the composition is monophasic O3 type layered structure with a space group of R-3m.

In the aspect of the present invention, wherein the composition of cathode electrode active material voltage window ranges from 2 V to 4.4 V.

In further aspect of the present invention, wherein the composition cathode material capacity ranges from 70 mA h/g to 195 mA h/g.

In further aspect of the present invention, wherein the composition cathode material morphology is irregular granular, plate-like particles, hexagons, cubes, spheres, and elongated hexagons.

In further aspect of the present invention, wherein the sodium ion battery (100) containing biphasic multivalent layered oxide cathode materials composition (106) coated with aluminum foil; an anode (102) coated with aluminum foil; an electrolyte (108) and a porous separator (104).

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 presents the schematic representation of a Sodium-ion battery, in accordance with an embodiment of the present disclosure

FIG. 2A presents an X-ray diffraction pattern of Na_{0.97}Ca_{0.03}Ni_{0.4}Cu_{0.1}Al_{0.05}Mn_{0.3}Ti_{0.1}Sb_{0.05}O₂ cathode material composition, in accordance with an embodiment of the present disclosure.

FIG. 2B presents an X-ray diffraction pattern of water treated Na_{0.97}Ca_{0.03}Ni_{0.4}Cu_{0.1}Al_{0.05}Mn_{0.3}Ti_{0.1}Sb_{0.05}O₂ cathode material composition, in accordance with an embodiment of the present disclosure.

FIG. 2C presents an X-ray diffraction pattern of Na_{0.98}Ni_{0.25}Cu_{0.091}Mn_{0.375}Ti_{0.2}Sb_{0.0833}O₂ cathode material composition, in accordance with an embodiment of the present disclosure.

FIG. 2D presents an X-ray diffraction pattern of water treated Na_{0.98}Ni_{0.25}Cu_{0.091}Mn_{0.375}Ti_{0.2}Sb_{0.0833}O₂ cathode material composition, in accordance with an embodiment of the present disclosure.

FIG. 2E presents an X-ray diffraction pattern of Na_{0.96}Ca_{0.04}Ni_{0.25}Cu_{0.125}Mn_{0.375}Ti_{0.166}Sb_{0.083}O₂ cathode material composition, in accordance with an embodiment of the present disclosure

FIG. 2F presents an X-ray diffraction pattern of water treated Na_{0.96}Ca_{0.04}Ni_{0.25}Cu_{0.125}Mn_{0.375}Ti_{0.166}Sb_{0.083}O₂ cathode material composition, in accordance with an embodiment of the present disclosure

FIG. 2G presents an X-ray diffraction pattern of Na_{0.8}Ca_{0.2}Ni_{0.6}Mn_{0.2}Ti_{0.2}O₂ cathode material composition, in accordance with an embodiment of the present disclosure

FIG. 2H presents an X-ray diffraction pattern of water treated Na_{0.8}Ca_{0.2}Ni_{0.6}Mn_{0.2}Ti_{0.2}O₂ cathode material composition, in accordance with an embodiment of the present disclosure

FIG. 2I presents an X-ray diffraction pattern of NaN_{1/6}Mg_{1/6}Cu_{1/6}Co_{1/6}Fe_{1/6}Mn_{1/8}Ti_{1/8}O₂ cathode material composition, in accordance with an embodiment of the present disclosure

FIG. 2J presents an X-ray diffraction pattern of water treated NaN_{1/6}Mg_{1/6}Cu_{1/6}Co_{1/6}Fe_{1/6}Mn_{1/8}Ti_{1/8}O₂ cathode material composition, in accordance with an embodiment of the present disclosure

FIG. 2K presents an X-ray diffraction pattern of Na_{0.95}Ca_{0.05}Ni_{0.4}Cu_{0.1}Al_{0.05}Mn_{0.3}Ti_{0.1}Sb_{0.05}O₂ cathode material composition, in accordance with an embodiment of the present disclosure

FIG. 2L presents an X-ray diffraction pattern of water treated Na_{0.95}Ca_{0.05}Ni_{0.4}Cu_{0.1}Al_{0.05}Mn_{0.3}Ti_{0.1}Sb_{0.05}O₂ cathode material composition, in accordance with an embodiment of the present disclosure

FIG. 2M presents an X-ray diffraction pattern of Na_{0.95}Ca_{0.05}Ni_{0.6}Mn_{0.2}Ti_{0.1}Sb_{0.1}O₂ cathode material composition, in accordance with an embodiment of the present disclosure

FIG. 2N presents an X-ray diffraction pattern of water treated Na_{0.95}Ca_{0.05}Ni_{0.6}Mn_{0.2}Ti_{0.1}Sb_{0.1}O₂ cathode material composition, in accordance with an embodiment of the present disclosure

FIG. 2O presents an X-ray diffraction pattern of Na_{0.96}Ca_{0.02}Ni_{0.45}Cu_{0.1}Mn_{0.25}Ti_{0.1}Sb_{0.1}O₂ cathode material composition, in accordance with an embodiment of the present disclosure

FIG. 2P presents an X-ray diffraction pattern of water treated Na_{0.96}Ca_{0.02}Ni_{0.45}Cu_{0.1}Mn_{0.25}Ti_{0.1}Sb_{0.1}O₂ cathode material composition, in accordance with an embodiment of the present disclosure

FIG. 2Q presents an X-ray diffraction pattern of Na_{0.97}Ca_{0.03}Li_{0.02}Ni_{0.5}Cu_{0.05}Mn_{0.2}Ti_{0.1}Sb_{0.13}O₂ cathode material composition, in accordance with an embodiment of the present disclosure

FIG. 2R presents an X-ray diffraction pattern of water treated Na_{0.97}Ca_{0.03}Li_{0.02}Ni_{0.5}Cu_{0.05}Mn_{0.2}Ti_{0.1}Sb_{0.13}O₂ material composition, in accordance with an embodiment of the present disclosure

FIG. 2S presents an X-ray diffraction pattern of NaCu_{0.1}Ni_{0.15}Fe_{0.30}Mn_{0.35}Ti_{0.05}Sb_{0.02}O₂ cathode material composition, in accordance with an embodiment of the present disclosure

FIG. 2T presents an X-ray diffraction pattern of water treated NaCu_{0.1}Ni_{0.15}Fe_{0.30}Mn_{0.35}Ti_{0.05}Sb_{0.02}O₂ cathode material composition, in accordance with an embodiment of the present disclosure

FIG. 3A presents a Voltage-time plot of Sodium-half cells fabricated with Na_{0.97}Ca_{0.03}Ni_{0.4}Cu_{0.1}Al_{0.05}Mn_{0.3}Ti_{0.1}Sb_{0.05}O₂ cathode material, in accordance with an embodiment of the present disclosure

FIG. 3B presents a Capacity vs Cycle no plot of Sodium-half cells fabricated with cathode water washed Na_{0.97}Ca_{0.03}Ni_{0.4}Cu_{0.1}Al_{0.05}Mn_{0.3}Ti_{0.1}Sb_{0.05}O₂ material, in accordance with an embodiment of the present disclosure

FIG. 3C presents a Voltage-time plot of Sodium-half cells fabricated with Na_{0.98}Ni_{0.25}Cu_{0.091}Mn_{0.375}Ti_{0.2}Sb_{0.0833}O₂ cathode material, in accordance with an embodiment of the present disclosure

FIG. 3D presents a Capacity vs Cycle no plot of Sodium-half cells fabricated with cathode Na_{0.98}Ni_{0.25}Cu_{0.091}Mn_{0.375}Ti_{0.2}Sb_{0.0833}O₂ material, in accordance with an embodiment of the present disclosure

FIG. 3E presents a Voltage-time plot of Sodium-half cells fabricated with Na_{0.96}Ca_{0.04}Ni_{0.25}Cu_{0.125}Mn_{0.375}Ti_{0.166}Sb_{0.083}O₂ cathode material, in accordance with an embodiment of the present disclosure

FIG. 3F presents a Capacity vs Cycle no plot of Sodium-half cells fabricated with cathode Na_{0.96}Ca_{0.04}Ni_{0.25}Cu_{0.125}Mn_{0.375}Ti_{0.166}Sb_{0.083}O₂ material, in accordance with an embodiment of the present disclosure

FIG. 3G illustrates a Voltage-time plot of Sodium-half cells fabricated with Na_{0.8}Ca_{0.2}Ni_{0.6}Mn_{0.2}Ti_{0.2}O₂ cathode material, in accordance with an embodiment of the present disclosure

FIG. 3H presents a Voltage-time plot of Sodium-half cells fabricated with NaN_{1/6}Mg_{1/6}Cu_{1/6}Co_{1/6}Fe_{1/6}Mn_{1/8}Ti_{1/8}O₂ cathode material, in accordance with an embodiment of the present disclosure.

FIG. 3I presents a Voltage-time plot of Sodium-half cells fabricated with cathode Na_{0.96}Ca_{0.02}Ni_{0.45}Cu_{0.1}Mn_{0.25}Ti_{0.1}Sb_{0.1}O₂ cathode material, in accordance with an embodiment of the present disclosure.

FIG. 3J presents a Voltage-time plot of Sodium-half cells fabricated with cathode Na_{0.97}Ca_{0.03}Li_{0.02}Ni_{0.5}Cu_{0.05}Mn_{0.2}Ti_{0.1}Sb_{0.13}O₂ cathode material, in accordance with an embodiment of the present disclosure.

FIG. 4A presents a FESEM image of Na_{0.97}Ca_{0.03}Ni_{0.4}Cu_{0.1}Al_{0.05}Mn_{0.3}Ti_{0.1}Sb_{0.05}O₂ cathode material composition, in accordance with an embodiment of the present disclosure.

FIG. 4B presents a FESEM image of Na_{0.98}Ni_{0.25}Cu_{0.091}Mn_{0.375}Ti_{0.2}Sb_{0.0833}O₂ cathode material composition, in accordance with an embodiment of the present disclosure.

FIG. 4C presents a FESEM image of Na_{0.96}Ca_{0.04}Ni_{0.25}Cu_{0.125}Mn_{0.375}Ti_{0.166}Sb_{0.083}O₂ cathode material composition, in accordance with an embodiment of the present disclosure.

FIG. 4D presents a FESEM image of Na_{0.96}Ca_{0.02}Ni_{0.45}Cu_{0.1}Mn_{0.25}Ti_{0.1}Sb_{0.1}O₂ cathode material composition, in accordance with an embodiment of the present disclosure.

### DETAILED DESCRIPTION OF THE PRESENT INVENTION

The following description includes the preferred best mode of one embodiment of the present invention. It will be clear from this description of the invention that the invention is not limited to these illustrated embodiments but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” “consists essentially of,” and the like or the respective closed phrases “consisting of,” “consists of,” the like.

As used herein, the singular forms “a”, “an”, and “the” designate both the singular and the plural, unless expressly stated to designate the singular only.

According to embodiments of the present invention, the cathode compositions were synthesized by simple and facile solid-state method. Stoichiometric amounts of precursors were thoroughly mixed and ground in agate mortar or ball milled for 30 min to 5 hours and calcinated at 400 to 700° C. for 2 to 10 h at air or argon atmosphere, followed by intermediate grinding or ball milling for 1 to 10 h. The milled powder was calcinated at 700 to 1000° C. in air or argon atmosphere for 5 to 20 h. After cooling, the obtained cathode compositions were stored in Ar-filled glove box to protect from moisture.

Preferably the mixture of precursor materials comprises one or more compounds selected from Na₂CO₃, Li₂CO₃, LiOH·xH₂O, NiO, NiCO₃, Ni(OH)₂·xH₂O, MnO₂, MnO, Mn₂O₃, Mg(OH)₂, MgO, TiO₂, Al(OH)₃, Al₂O₃, CuO, ZnO, Sb₂O₃, Sb₂O₅.

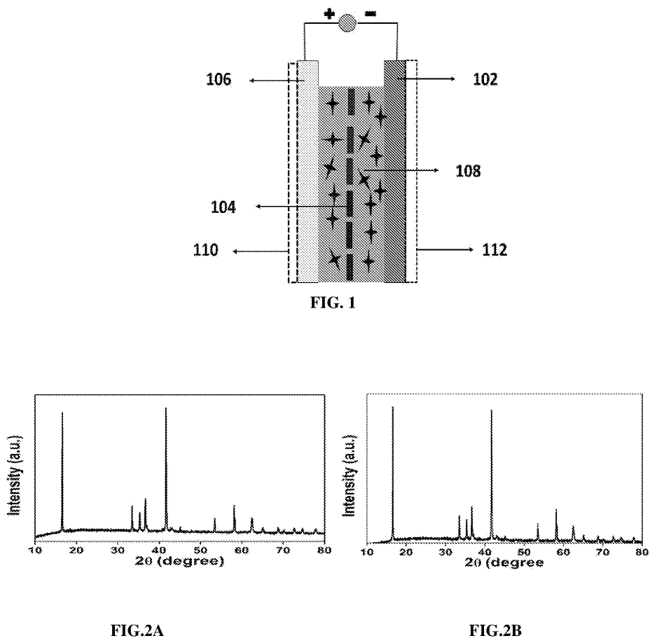

FIG. 1 shows a schematic representation of a Sodium-ion battery 100, according to embodiments of the present invention. A sodium-ion battery consists of two electrodes, one is cathode 106 and hard carbon anode 102, separated by a porous separator 104 immersed in a nonaqueous sodium-ion conducting liquid electrolyte 108 using sodium salt in a mixture of organic solvents and additives.

According to embodiments of the present invention, the cathode electrode is prepared by solvent-casting a slurry of the active cathode material 106, conductive carbon, binder and solvent. The conductive carbon used is Super P, the binder used as PVDF and N-methyl-2-pyrrolidone (NMP) as the solvent. wherein positive electrode material coated with aluminum foil (112); an anode coated with aluminum or copper foil (110); Then the slurry is cast onto aluminum foil after that kept it for drying oven at 120° C. for 12 hours to obtain the positive electrode.

According to embodiments of the present invention, while charging Na-ions move from the cathode (106) NaMO₂ layered structure to the anode (102) side, during discharging, Na-ions move back to the MO₂ host framework but the electrons are transformed to the external circuit.

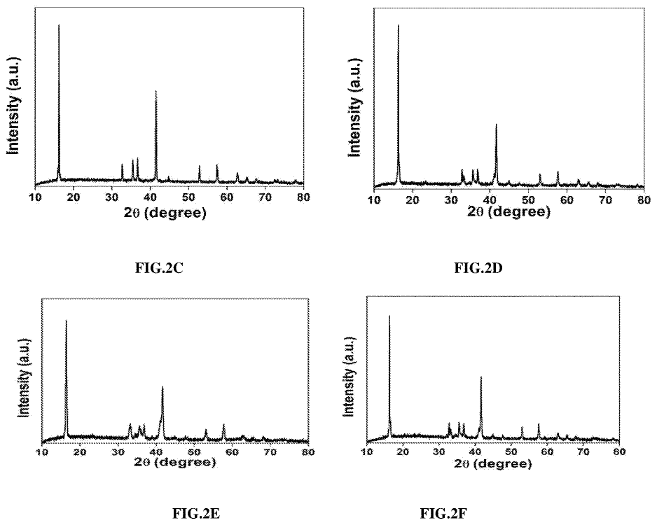

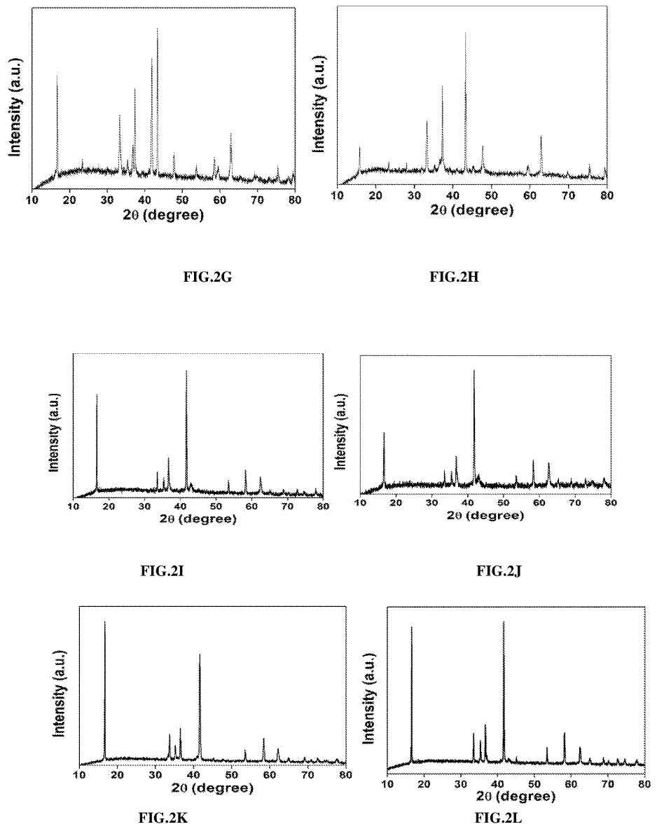

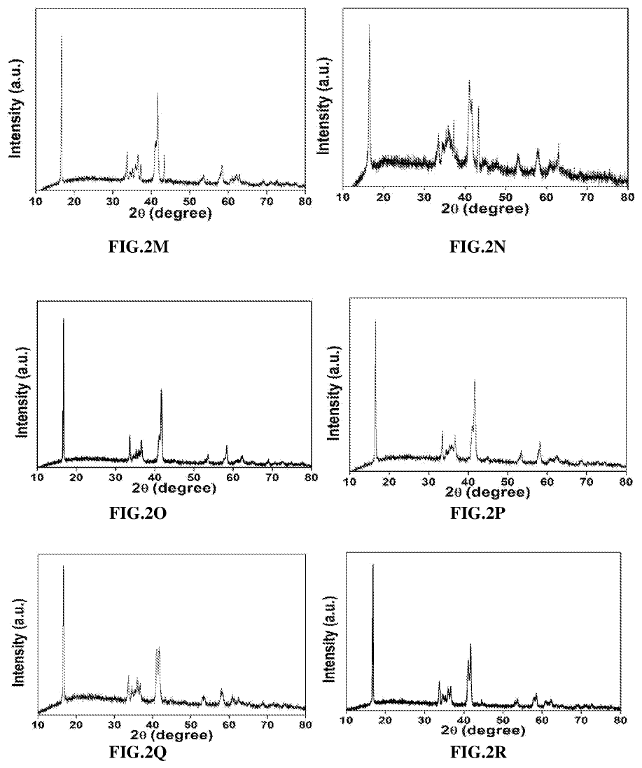

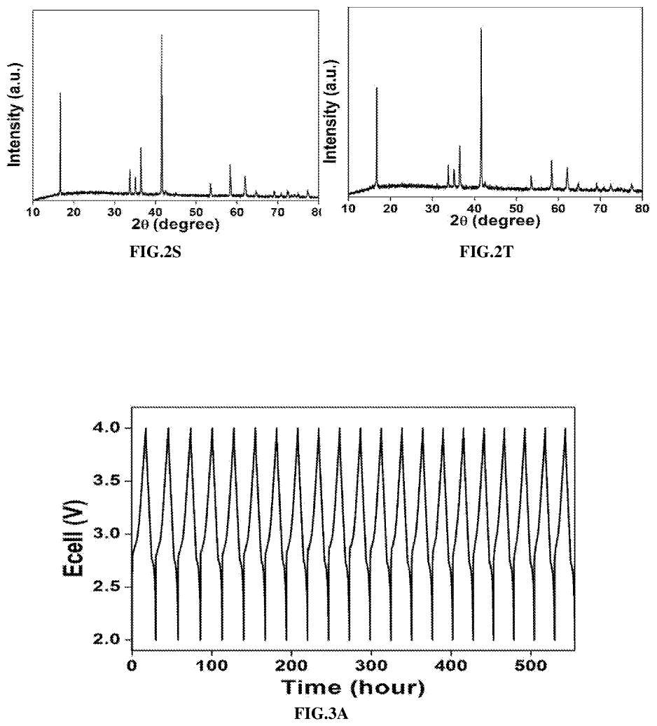

FIG. 2A shows an X-ray diffraction pattern of Na_{0.97}Ca_{0.03}Ni_{0.4}Cu_{0.1}Al_{0.05}Mn_{0.3}Ti_{0.1}Sb_{0.05}O₂ the cathode material, according to embodiments of the present invention. X-ray diffraction (XRD) a quick method to identify the formation of the required cathode material composition phase through a crystal structure analysis. In an embodiment of the present invention, the cathode material composition characterized by performing a Bruker D8 ADVANCE Diffractometer. According to an embodiment of the present invention, the diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2B shows an X-ray diffraction pattern of water treated Na_{0.97}Ca_{0.03}Ni_{0.4}Cu_{0.1}Al_{0.05}Mn_{0.3}Ti_{0.1}Sb_{0.05}O₂ the cathode material, according to embodiments of the present invention. The sample is stirred in water for 30 minutes. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2C shows an X-ray diffraction pattern of Na_{0.98}Ni_{0.25}Cu_{0.091}Mn_{0.375}Ti_{0.2}Sb_{0.0833}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2D shows an X-ray diffraction pattern of water treated Na_{0.98}Ni_{0.25}Cu_{0.091}Mn_{0.375}Ti_{0.2}Sb_{0.0833}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2E shows an X-ray diffraction pattern of Na_{0.96}Ca_{0.04}Ni_{0.25}Cu_{0.125}Mn_{0.375}Ti_{0.166}Sb_{0.083}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2F shows an X-ray diffraction pattern of water treated Na_{0.96}Ca_{0.04}Ni_{0.25}Cu_{0.125}Mn_{0.375}Ti_{0.166}Sb_{0.083}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2G shows an X-ray diffraction pattern of Na_{0.8}Ca_{0.2}Ni_{0.6}Mn_{0.2}Ti_{0.2}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2H shows an X-ray diffraction pattern of water treated Na_{0.8}Ca_{0.2}Ni_{0.6}Mn_{0.2}Ti_{0.2}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2I shows an X-ray diffraction pattern of NaN_{1/6}Mg_{1/6}Cu_{1/6}Co_{1/6}Fe_{1/6}Mn_{1/8}Ti_{1/8}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2J shows an X-ray diffraction pattern of water treated NaN_{1/6}Mg_{1/6}Cu_{1/6}Co_{1/6}Fe_{1/6}Mn_{1/8}Ti_{1/8}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2K shows an X-ray diffraction pattern of Na_{0.95}Ca_{0.05}Ni_{0.4}Cu_{0.1}Al_{0.05}Mn_{0.3}Ti_{0.1}Sb_{0.05}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2L shows an X-ray diffraction pattern of water treated Na_{0.95}Ca_{0.05}Ni_{0.4}Cu_{0.1}Al_{0.05}Mn_{0.3}Ti_{0.1}Sb_{0.05}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2M shows an X-ray diffraction pattern of Na_{0.95}Ca_{0.05}Ni_{0.6}Mn_{0.2}Ti_{0.1}Sb_{0.1}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2N shows an X-ray diffraction pattern of water treated Na_{0.95}Ca_{0.05}Ni_{0.6}Mn_{0.2}Ti_{0.1}Sb_{0.1}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2O shows an X-ray diffraction pattern of Na_{0.96}Ca_{0.02}Ni_{0.45}Cu_{0.1}Mn_{0.25}Ti_{0.1}Sb_{0.1}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2P shows an X-ray diffraction pattern of water treated Na_{0.96}Ca_{0.02}Ni_{0.45}Cu_{0.1}Mn_{0.25}Ti_{0.1}Sb_{0.1}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2Q shows an X-ray diffraction pattern of Na_{0.97}Ca_{0.03}Li_{0.02}Ni_{0.5}Cu_{0.05}Mn_{0.2}Ti_{0.1}Sb_{0.13}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2R shows an X-ray diffraction pattern of water treated Na_{0.97}Ca_{0.03}Li_{0.02}Ni_{0.5}Cu_{0.05}Mn_{0.2}Ti_{0.1}Sb_{0.13}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2S shows an X-ray diffraction pattern of NaCu_{0.1}Ni_{0.15}Fe_{0.30}Mn_{0.35}Ti_{0.05}Sb_{0.02}O₂ the cathode material, according to embodiments of the present invention. The diffraction peaks correspond to a layered compound, and no other impurity peaks are observed. The high intense peaks confirm that the material is crystalline. The XRD pattern shows that cathode composition is a monophasic O3-type layered structure and space group is R-3m.

FIG. 2T shows an X-ray diffraction pattern of water treated NaCu_{0.1}Ni_{0.15}Fe_{0.30}Mn_{0.35}Ti_{0.05}Sb_{0.02}O₂ the cathode material, according to embodiments of the present invention. The sample stirred in water for 30 minutes The diffraction peaks correspond to a layered compound, and no other impurity peaks are observed. The high intense peaks confirm that the material is crystalline. The XRD pattern shows that cathode composition is a monophasic O3-type layered structure and space group is R-3m.

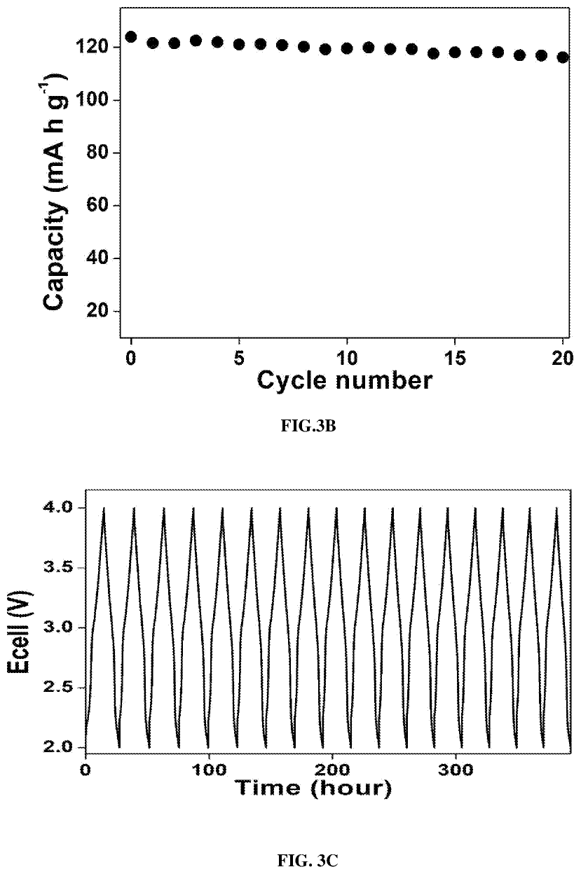

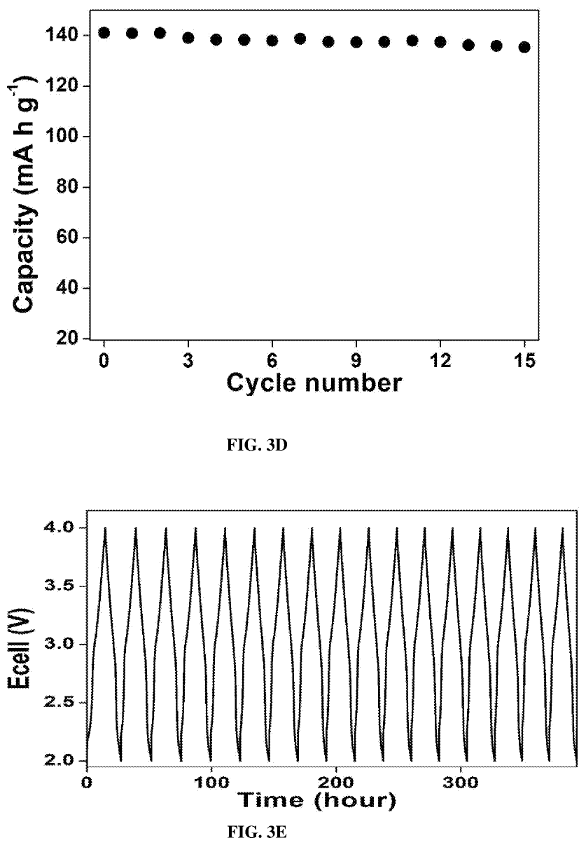

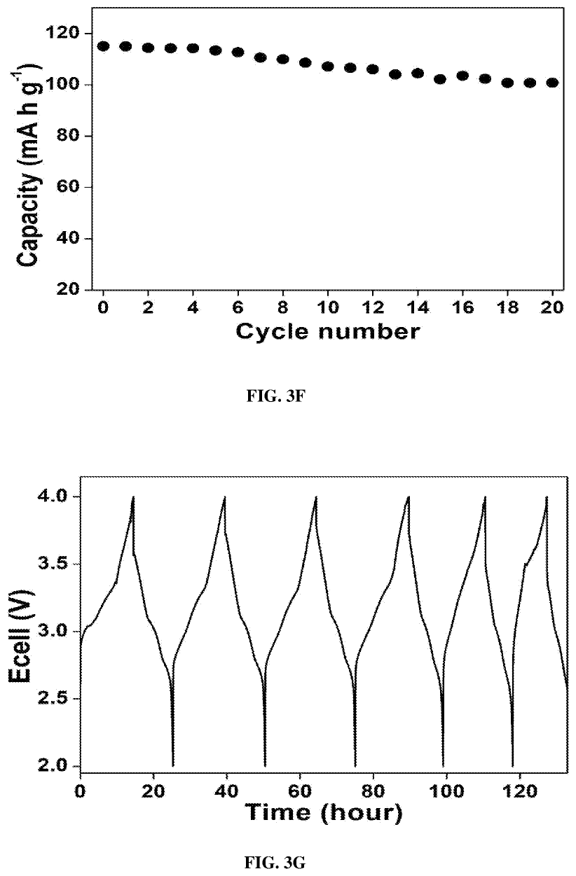

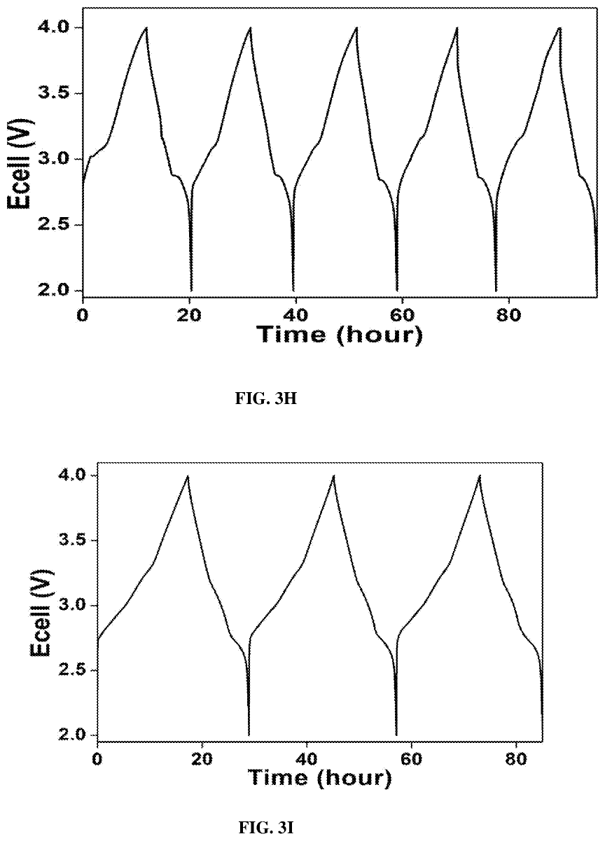

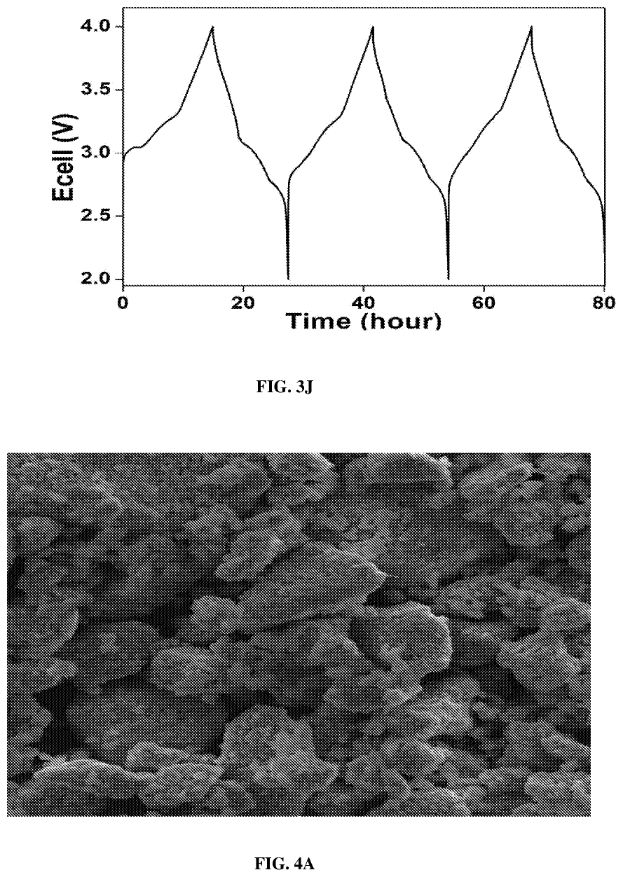

FIG. 3A illustrates Voltage-Time plot of Sodium-half cells fabricated with Na_{0.97}Ca_{0.03}Ni_{0.4}Cu_{0.1}Al_{0.05}Mn_{0.3}Ti_{0.1}Sb_{0.05}O₂ cathode material. According to embodiments of the present invention, the active cathode material composition characterized by a BioLogic BCS-800 series battery cycler. The voltage-time plot help to determine the time period for charge, voltage window and cycling stability of the cathode active material. The present invention exhibited charge and discharge capacities of ~152 mAh/g and ~123 mAh/g respectively at current densities equivalent to C/25, within a cell voltage window of 2-4V. Na ~0.52 moles are reversibly intercalated into the structure. First two cycles discharge capacity fade was 1.02% and the columbic efficiency is 81%.

FIG. 3B illustrates Specific Capacity-Cycle no plot of Sodium-half cells fabricated with Na_{0.97}Ca_{0.03}Ni_{0.4}Cu_{0.1}Al_{0.05}Mn_{0.3}Ti_{0.1}Sb_{0.05}O₂ cathode material. According to embodiments of the present invention, the Capacity-Cycle help to determine the voltage window and cycling stability of the cathode active material. The present invention exhibited charge and discharge capacities of ~152 mAh/g and ~123 mAh/g respectively at current densities equivalent to C/25, within a cell voltage window of 2-4V. The capacity retention after the 20 cycles is 93%.

FIG. 3C illustrates Voltage-Time plot of Sodium-half cells fabricated with Na_{0.98}Ni_{0.25}Cu_{0.091}Mn_{0.375}Ti_{0.2}Sb_{0.0833}O₂ cathode material. According to embodiments of the present invention, the voltage-time plot help to determine the time period for charge, voltage window and cycling stability of the cathode active material. The present invention exhibited charge and discharge capacities of ~141.27 and ~140.956 mAh/g respectively at current densities equivalent to C/25, within a cell voltage window of 2-4V. Na ~0.6 moles are reversibly intercalated into the structure. First two cycles discharge capacity fade was 1.03% and the columbic efficiency is 99%.

FIG. 3D illustrates Specific Capacity-Cycle no plot of Sodium-half cells fabricated with Na_{0.98}Ni_{0.25}Cu_{0.091}Mn_{0.375}Ti_{0.2}Sb_{0.0833}O₂ cathode material. According to embodiments of the present invention, the Capacity-Cycle help to determine the voltage window and cycling stability of the cathode active material. The present invention exhibited charge and discharge capacities of ~141.27 mAh/g and ~140.95 mAh/g respectively at current densities equivalent to C/25, within a cell voltage window of 2-4V. The capacity retention after the 16 cycles is 95%.

FIG. 3E illustrates Voltage-Time plot of Sodium-half cells fabricated with Na_{0.96}Ca_{0.04}Ni_{0.25}Cu_{0.125}Mn_{0.375}Ti_{0.166}Sb_{0.083}O₂ cathode material. According to embodiments of the present invention, the voltage-time plot help to determine the time period for charge, voltage window and cycling stability of the cathode active material. The present invention exhibited charge and discharge capacities of ~121 and ~114.9 mAh/g respectively at current densities equivalent to C/25, within a cell voltage window of 2-4V. Na ~0.6 moles are reversibly intercalated into the structure. First two cycles discharge capacity fade was 1.014% and the columbic efficiency is 94%.

FIG. 3F illustrates Specific Capacity-Cycle no plot of Sodium-half cells fabricated with Na_{0.96}Ca_{0.04}Ni_{0.25}Cu_{0.125}Mn_{0.375}Ti_{0.166}Sb_{0.083}O₂ cathode material. According to embodiments of the present invention, the Capacity-Cycle help to determine the voltage window and cycling stability of the cathode active material. The present invention exhibited charge and discharge capacities of ~121 mAh/g and ~114.9 mAh/g respectively at current densities equivalent to C/25, within a cell voltage window of 2-4V. The capacity retention after the 20 cycles is 90%.

FIG. 3G illustrates Voltage-Time plot of Sodium-half cells fabricated with Na_{0.8}Ca_{0.2}Ni_{0.6}Mn_{0.2}Ti_{0.2}O₂ cathode material. According to embodiments of the present invention, the voltage-time plot help to determine the time period for charge, voltage window and cycling stability of the cathode active material The present invention exhibited charge and discharge capacities of ~127 and ~109 mAh/g respectively at current densities equivalent to C/25, within a cell voltage window of 2-4V. Na ~0.46 moles are reversibly intercalated into the structure. First two cycles discharge capacity fade was 1.016% and the columbic efficiency is 86%.

FIG. 3H illustrates Voltage-Time plot of Sodium-half cells fabricated with NaN_{1/6}Mg_{1/6}Cu_{1/6}Co_{1/6}Fe_{1/6}Mn_{1/8}Ti_{1/8}O₂ cathode material. According to embodiments of the present invention, the voltage-time plot help to determine the time period for charge, voltage window and cycling stability of the cathode active material The present invention exhibited charge and discharge capacities of ~103 and ~90 mAh/g respectively at current densities equivalent to C/25, within a cell voltage window of 2-4V. Na ~0.38 moles are reversibly intercalated into the structure. First two cycles discharge capacity fade was 1.013% and the columbic efficiency is 86%.

FIG. 3I illustrates Voltage-Time plot of Sodium-half cells fabricated with Na_{0.96}Ca_{0.02}Ni_{0.45}Cu_{0.1}Mn_{0.25}Ti_{0.1}Sb_{0.1}O₂ cathode material. According to embodiments of the present invention, the voltage-time plot help to determine the time period for charge, voltage window and cycling stability of the cathode active material The present invention exhibited charge and discharge capacities of ~138 and ~117 mAh/g respectively at current densities equivalent to C/25, within a cell voltage window of 2-4.4V. Na ~0.52 moles are reversibly intercalated into the structure. First two cycles discharge capacity fade was 1.015% and the columbic efficiency is 84%.

FIG. 3J illustrates Voltage-Time plot of Sodium-half cells fabricated with Na_{0.97}Ca_{0.03}Li_{0.02}Ni_{0.5}Cu_{0.05}Mn_{0.2}Ti_{0.1}Sb_{0.13}O₂ cathode material. According to embodiments of the present invention, the voltage-time plot help to determine the time period for charge, voltage window and cycling stability of the cathode active material The present invention exhibited charge and discharge capacities of ~126 and ~118 mAh/g respectively at current densities equivalent to C/25, within a cell voltage window of 2-4V. Na ~0.50 moles are reversibly intercalated into the structure. First two cycles discharge capacity fade was 1.02% and the columbic efficiency is 93%.

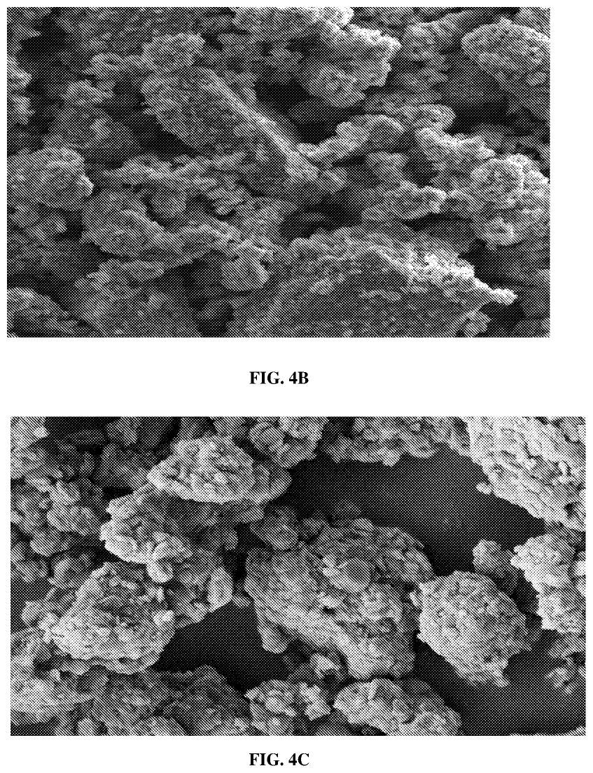

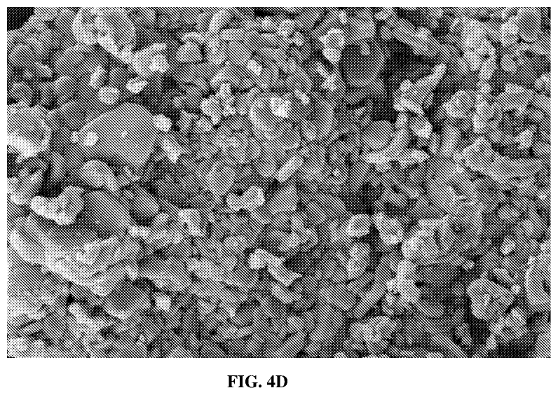

FIG. 4A illustrates a FESEM image of Na_{0.97}Ca_{0.03}Ni_{0.4}Cu_{0.1}Al_{0.05}Mn_{0.3}Ti_{0.1}Sb_{0.05}O₂ cathode active material composition, according to embodiments of the present invention. The morphology of cathode active material composition investigated by the Carl Zeiss 130 VP Field Emission Scanning Electron Microscope (FESEM). In an embodiment of the present invention, micrographs show that the morphologies of the solid-state synthesized cathode active material composition produce irregular granular morphology and polygonal shape particles, Further, the cathode active material composition is composed of different morphologies, such as, but not limited to, rhombohedra, hexagons, polygonal, cubes, spheres, elongated hexagons, and so forth.

FIG. 4B illustrates a FESEM image of Na_{0.98}Ni_{0.25}Cu_{0.091}Mn_{0.375}Ti_{0.2}Sb_{0.0833}O₂ cathode active material composition, according to embodiments of the present invention, micrographs show that the morphologies of the solid-state synthesized cathode active material composition produce irregular granular morphology. Further, the cathode active material composition is composed of different morphologies, such as, but not limited to, rhombohedra, hexagons, cubes, polygonal, spheres, elongated hexagons, and so forth.

FIG. 4C illustrates a FESEM image of Na_{0.96}Ca_{0.04}Ni_{0.25}Cu_{0.125}Mn_{0.375}Ti_{0.166}Sb_{0.083}O₂ cathode active material composition, according to embodiments of the present invention, micrographs show that the morphologies of the solid-state synthesized cathode active material composition produce morphology plate-like particles. Further, the cathode active material composition is composed of different morphologies, such as, but not limited to, rhombohedra, hexagons, cubes, spheres, polygonal, elongated hexagons, and so forth.

FIG. 4D illustrates a FESEM image of Na_{0.96}Ca_{0.02}Ni_{0.45}Cu_{0.1}Mn_{0.25}Ti_{0.1}Sb_{0.1}O₂ cathode active material composition, according to embodiments of the present invention, micrographs show that the morphologies of the solid-state synthesized cathode active material composition produce indefinite granular morphology. Further, the cathode active material composition is composed of different morphologies, such as, but not limited to, rhombohedra, hexagons, cubes, spheres, polygonal, elongated hexagons, and so forth.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope the invention is defined in the claims, and may include other examples that occur to those skilled in the art. Such other examples are intended to be within the scope of the claims if they have structural elements that do not differ from the literal language of the claims, or if they include equivalent structural elements within substantial differences from the literal languages of the claims.

### EXAMPLES

The following examples are given by way of illustration of the working of the invention in actual practice and therefore should not be constrained to limit the scope of the present invention.

### Example 1

Multivalent cathode material composition represented by Na_{0.97}Ca_{0.03}Ni_{0.4}Cu_{0.1}Al_{0.05}Mn_{0.3}Ti_{0.1}Sb_{0.05}O₂. According to embodiments of the present invention the composition was prepared by solid-state method. Stoichiometric amounts of precursors CaCO₃, NiO, CuO, Al₂O₃, MnO₂, TiO₂, Sb₂O₃, and Na₂CO₃, were thoroughly mixed and ground in agate mortar for 30 min and calcinated at 400° C. for 2 h at air, followed by intermediate ball milling for 3 h. The milled powder was calcinated at 700° C. in air 20 h. The x-ray diffraction (XRD) pattern shown in FIG. 2A confirmed the composition was monophasic all peaks were matching with the O3 phase which belonged to rhombohedral crystal structure having space group R-3m. The moisture sensitivity was assessed by immersing the cathode material sample in water for 30 mins to 10 hrs followed by filtering and drying at 100° C. in oven. According to embodiments of the invention the field emission scanning electron microscopy (FESEM) micrograph represented in FIG. 4A showed that the morphology of cathode material composition was plate like with irregular shape. According to embodiments of the invention, the voltage v/s time plot represented in FIG. 3A showed that the Sodium half-cell fabricated with cathode material exhibited charge and discharge capacities of ~152 and ~123 mAh/g respectively at current densities equivalent to C/25, within a cell voltage window of 2-4V.

### Example 2

Multivalent cathode material composition represented by Na_{0.98}Ni_{0.25}Cu_{0.091}Mn_{0.375}Ti_{0.2}Sb_{0.0833}O₂. According to embodiments of the present invention the composition was prepared by Solid-state method. Stoichiometric amounts of precursors NiO, CuO, Mn₂O₃, TiO₂, Sb₂O₃ and Na₂CO₃ were thoroughly mixed and ball milled for 10 h and calcinated at 700° C. for 10 h at air, followed by intermediate ball milling for 10 h. The milled powder was calcinated at 800° C. in air 10 h. The XRD pattern shown in FIG. 2C confirmed the composition was monophasic all peaks were matching with the O3 phase which belonged to rhombohedral crystal structure having space group R-3m. The moisture sensitivity was assessed by immersing sample in water for 30 mins to 10 hrs followed by filtering and drying at 100° C. in oven. According to embodiments of the invention, the FESEM micrograph represented in FIG. 4B it showed that the morphology of composition had irregular shape. According to embodiments of the invention the voltage v/s time plot represented in FIG. 3C shows that the Sodium half-cell fabricated with cathode material exhibited charge and discharge capacities of ~141 and ~140 mAh/g respectively at current densities equivalent to C/25, within a cell voltage window of 2-4V.

### Example 3

Multivalent cathode material composition represented by Na_{0.96}Ca_{0.04}Ni_{0.25}Cu_{0.125}Mn_{0.375}Ti_{0.166}Sb_{0.083}O₂. According to embodiments of the present invention the composition was prepared by Solid-state method. Stoichiometric amounts of precursors CaCO₃, Ni(OH)₂·xH₂O, CuO, MnO₂, TiO₂, Sb₂O₃ and Na₂CO₃ were thoroughly mixed and ball milled for 2 h and calcinated at 500° C. for 3 h at air, followed by intermediate ball milling for 2 h. The milled powder was calcinated at 800° C. in air 15 h. The XRD pattern shown in FIG. 2E confirms the composition is monophasic all peaks are matching with the O3 phase which belongs to rhombohedral crystal structure having space group R-3m. The moisture sensitivity is assessed by immersing sample in water for 30 mins to 10 hrs followed by filtering and drying at 100° C. in oven. According to embodiments of the invention the FESEM micrograph represented in FIG. 4C it showed the morphology of composition plate like with irregular shape. According to embodiments of the invention the voltage v/s time plot represented in FIG. 3E shows the Sodium half-cell fabricated with cathode material it exhibited charge and discharge capacities of ~121 and ~114 mAh/g respectively at current densities equivalent to C/25, within a cell voltage window of 2-4V.

### Example 4

Multivalent cathode material composition represented by Na_{0.96}Ca_{0.02}Ni_{0.45}Cu_{0.1}Mn_{0.25}Ti_{0.1}Sb_{0.1}O₂. According to embodiments of the present invention the composition was prepared by Solid-state method. Stoichiometric amounts of precursors CaCO₃, NiCO₃, CuO, MnO₂, TiO₂, Sb₂O₃ and Na₂CO₃, were thoroughly mixed and ball milled for 5 h and calcinated at 600° C. for 5 h at air, followed by intermediate ball milling for 5 h. The milled powder was calcinated at 900° C. in air 5 h. The XRD pattern shown in FIG. 2O confirms the composition is monophasic all peaks were matching with the O3 phase which belonged to rhombohedral crystal structure having space group R-3m. The moisture sensitivity was assessed by immersing sample in water for 30 mins to 10 hrs followed by filtering and drying at 100° C. in oven. According to embodiments of the invention the FESEM micrograph represented in FIG. 4D it shows the morphology of composition is plate like with irregular shape. According to embodiments of the invention the voltage v/s time plot represented in FIG. 3I shows the Sodium half-cell fabricated with cathode material it exhibited charge and discharge capacities of ~138 and ~117 mAh/g respectively at current densities equivalent to C/25, within a cell voltage window of 2-4V.

### Example 5

Multivalent cathode material composition represented by Na_{0.8}Ca_{0.2}Ni_{0.6}Mn_{0.2}Ti_{0.2}O₂ According to embodiments of the present invention the composition was prepared by Solid-state method. Stoichiometric amounts of precursors CaCO₃, NiO, CuO, MnO₂, TiO₂, Sb₂O₃ and Na₂CO₃ were thoroughly mixed and ground in agate mortar for 3 h and calcinated at 500° C. for 3 h at air, followed by intermediate ball milling for 5 h. The milled powder was calcinated at 850° C. in air 20 h. The XRD pattern shown in FIG. 2G confirmed the composition was monophasic all peaks were matching with the O3 phase which belonged to rhombohedral crystal structure having space group R-3m. The moisture sensitivity was assessed by immersing sample in water for 30 mins to 10 hrs followed by filtering and drying at 100° C. in oven. According to embodiments of the invention the voltage v/s time plot represented in FIG. 3G shows the Sodium half-cell fabricated with cathode material it exhibited charge and discharge capacities of ~127 and ~109 mAh/g respectively at current densities equivalent to C/25, within a cell voltage window of 2-4V.

### Example 6

Multivalent cathode material composition represented by NaN_{1/6}Mg_{1/6}Cu_{1/6}Co_{1/6}Fe_{1/6}Mn_{1/8}Ti_{1/8}O₂. According to embodiments of the present invention the composition was prepared by Solid-state method. Stoichiometric amounts of precursors NiO, MgO, CuO, CO₃O₄, MnO₂, Fe₃O₄O TiO₂, Sb₂O₃ and Na₂CO₃ were thoroughly mixed and ground in agate mortar for 1 h and calcinated at 400° C. for 2 h at air, followed by intermediate ball milling for 3 h The milled powder was calcinated at 700° C. in air 20 h. The XRD pattern shown in FIG. 2I confirms the composition is monophasic all peaks were matching with the O3 phase which belonged to rhombohedral crystal structure having space group R-3m. The moisture sensitivity was assessed by immersing sample in water for 30 mins to 10 hrs followed by filtering and drying at 100° C. in oven. According to embodiments of the invention the voltage v/s time plot represented in FIG. 3H shows the Sodium half-cell fabricated with cathode material it exhibited charge and discharge capacities of ~103 and ~90 mAh/g respectively at current densities equivalent to C/25, within a cell voltage window of 2-4V.

### Example 7

Multivalent cathode material composition represented by Na_{0.97}Ca_{0.03}Li_{0.02}Ni_{0.5}Cu_{0.05}Mn_{0.2}Ti_{0.1}Sb_{0.13}O₂. According to embodiments of the present invention the composition was prepared by Solid-state method. Stoichiometric amounts of precursors CaCO₃, Li₂CO₃, NiO, CuO, MnO₂, TiO₂, Sb₂O₃ and Na₂CO₃ were thoroughly mixed and ball milled for 10 h and calcinated at 700° C. for 10 h at air, followed by intermediate ball milling for 10 h. The milled powder was calcinated at 800° C. in air 10 h. The XRD pattern shown in FIG. 2A confirms the composition was monophasic all peaks were matching with the O3 phase which belonged to rhombohedral crystal structure having space group R-3m. The moisture sensitivity was assessed by immersing sample in water for 30 mins to 10 hrs followed by filtering and drying at 100° C. in oven. According to embodiments of the invention the voltage v/s time plot represented in FIG. 3Q shows the Sodium half-cell fabricated with cathode material it exhibited charge and discharge capacities of ~126 and ~118 mAh/g respectively at current densities equivalent to C/25, within a cell voltage window of 2-4V.

The invention is not limited to these materials, and examples of alternative cathodes includes

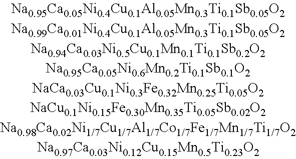

### Advantages of the Invention

The main advantages of the present invention are:
1. Moisture and air stable cathode material composition.
2. Improved cycling and high-voltage performance of the cathode materials.
3. Cathode material composition can be utilized for battery industry.
4. The composition formula contains abundant and low-cost elements.
5. Cathode material composition easily scalable for mass production.

1. An air and moisture stable layered oxide cathode material having formula NaₓA_{z}NiᵢM_{y}MnⱼTiₖSb_{f}O₂ where (i+j+k+f+y=1), 0.7≤x≤1, 0≤z≤0.2, 0≤y≤0.5, 0.1≤i≤0.6, 0.1≤j≤0.5, 0.05≤k≤0.4, 0≤f≤0.2,
a) wherein A is alkali or alkaline-earth metals selected from a Ca divalent element or a Li monovalent element;
b) M is a divalent or trivalent element selected from Fe, Mg, Zn, Cu, Al, Co, or combinations thereof, having oxidation state +2 and +3 respectively;
c) Ni is a divalent element having oxidation state +2;
d) Mn, and Ti are tetravalent elements having oxidation state +4; and
e) Sb is a pentavalent/trivalent element having oxidation state +5/+3.

2. The cathode material as claimed in claim 1, wherein the cathode material is selected from

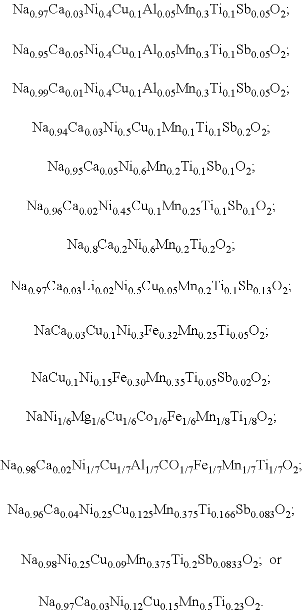

3. The cathode material as claimed in claim 2, wherein the cathode material has an O3 type layered structure.

4. The cathode material as claimed in claim 2, wherein the cathode material is monophasic with rhombohedral crystal structure and space group R-3m.

5. The cathode material as claimed in claim 2, wherein the cathode material exhibits a capacity in between 70 mAh/g to 195 mAh/g.

6. The cathode material as claimed in claim 2, wherein the cathode material operates in a voltage range of 2 to 4.5V.

7. A sodium ion battery containing air and moisture stable layered oxide cathode materials, comprising:
(i) a positive electrode having the monophasic cathode material as claimed in claim 1;
(ii) a negative electrode;
(iii) a non-aqueous electrolyte; and
(iv) a separator.
